(19) United States
(12) Patent Application Publication
(10) Pub. No.: US 2006/0071770 A1
(43) Pub. Date: Apr. 6, 2006

(54) Fiber optic cable sensor for movable objects

(76) Inventors: Frank Giotto, New Hartford, NY (US); James Hisert, Vernon, NY (US); Raymond Joseph Wertz, New York Mills, NY (US); Benjamin Lee Sitler, New Hartford, NY (US); Murray Joseph Selwyn Kirshtein, New Hartford, NY (US)

Correspondence Address: DAVID GIGLIO, ESQ., 231 ELIZABETH STREET, UTICA, NY, 13501, US

(21) Appl. No.: 11/035,187

(22) Filed: Jan. 14, 2005

Related U.S. Application Data
(63) Continuation-in-part of application No. 10/956,570, filed on Oct. 4, 2004.

(51) Int. Cl. G08B 23/00

(52) U.S. Cl. 340/500

(57) ABSTRACT

There is provided an apparatus that determines the location of an impermissible movement on a predetermined magnetically attractive object. A fiber optic cable runs through a housing and forms a first bend radius. A magnetic member disposed within said housing is magnetically attracted adjacent to the top of said housing by said predetermined magnetically attractive object. When said predetermined magnetically attractive object is impermissibly moved, the magnetic member falls downward thereby causing a microbend to said fiber optic cable. Using an optical time domain reflectometer, the location of the microbend along the cable is readily determined. Hydraulic fluid disposed within said housing passes through a one way valve and a two way valve disposed within said magnetic member to cause the magnetic member to fall at a faster rate and rise toward the predetermined magnetically attractive object at a slower rate, thus allowing for a sustainable period of time in which to determine the location of the microbend.

This application is a continuation in part application which claims priority from co-pending application Ser. No. 10/956,570 filed on Oct. 4, 2004 by the same inventors.

### FIELD OF THE INVENTION

The present invention relates generally to the field of electronic intrusion sensors and, more particularly, to a fiber optic cable based sensor system that locates an impermissible movement of an object to help prevent theft or terrorism.

### BACKGROUND OF THE INVENTION

There are many sensor systems that indicate the location of an intrusion attempt into a secure location or an attempt to steal a secure asset. For example, a door leading to a secure area might be rigged with a tamper switch that automatically relays a signal to a multiplexer and then onward to a de-multiplexer where the location of the intrusion is determined.

There are presently no interior intrusion detection systems that work for spark sensitive rooms such as those at oil refineries and others at power plants. The known systems for these applications include an electronic signal that can ignite the contents of the room, and thus cause an explosion.

Other types of systems include microwave sensors where a microwave transmitter and receiver are aligned and the intrusion attempt causes a break in the reception thereby triggering an alarm. Once again this type of system will not work inside of a spark sensitive room for the aforementioned reasons. These systems are bulky, expensive and highly noticeable.

These system also are tedious for many applications because much cabling is required to transmit signals indicative of an intrusion attempt. For instance, where a manhole system is desired to be protected from intrusion, (such as by terrorists) it would be necessary to install a great deal of cabling throughout the underground system. Further, this cabling is easily corrupted making the entire system suspect to tamper.

If wireless links were to be used, the reliability of the system is constantly in jeopardy because of the inherent unreliable nature of the wireless technology. An illustration of this is the common occurrence that interference from external sources causes disruption to wireless communications. It is noticeable that these antennas sometimes become unreliable during storms. Additionally, much expensive equipment and installation is required for wireless communications.

A manhole system typically carries underground utilities of which can include water drainage, water intake pipes, electrical systems, etc. A manhole cover provides access to such manhole systems for the purpose of repairs and maintenance.

It is a reasonable assumption that terrorists would like to gain access to underground utility systems because of the mass amount of urban destruction that can be attained in compromising such structures. In some cases, manhole covers are welded to their frames in anticipation of a large public event. Entrances may also be monitored by visual surveillance equipment. Each of these methods are costly and laborious.

Thieves often target works of art and other valuable items. There are certain electronic security systems for the protection of works of art, some of which include microwave transmitters and receivers. The microwave systems operate by sending a signal from a transmitter to a receiver. When the signal is interrupted, the system indicates an intrusion attempt.

These systems are expensive and suspect to tampering.

### OBJECTS AND SUMMARY OF THE PRESENT INVENTION

It is an object of the present invention to improve the field of security systems.

It is another object of the present invention to improve local, national and international security.

It is a further object of the present invention to provide an intrusion detection system that indicates when and where an intrusion is made on an underground utility system.

It is yet another object of the present invention to provide an intrusion detection system that indicates when and where a valuable item has been impermissibly moved.

It is still a further object of the present invention to provide an intrusion detection system that indicates when and where an intrusion attempt is made on spark sensitive room.

It is still yet another object of the present invention to tamper proof electronic intrusion detection system.

These and other and further objects are provided in accordance with the present invention in which an apparatus that determines the location of an impermissible tamper on an object, such as an impermissible attempt to gain access to a manhole system or an attempt to steal a work of art, includes a housing disposed adjacently to the object. A fiber optic cable runs through the housing. The object includes a portion that cooperates with internal components of the housing to maintain the fiber optic cable in a non-attenuated state.

Upon the impermissible tamper, that portion of the object no longer cooperates with the internal components of the housing. An elastic force internal to the housing cooperates with more internal housing components to create a microbend to the fiber optic cable.

Using known means, the location of the microbend along the fiber optic cable is readily discerned.

### BRIEF DESCRIPTION OF THE DRAWINGS

The above and other objects of the present invention will be better understood by reading the following detailed description of the preferred embodiments of the invention, when considered in conjunction with the accompanying drawings, in which:

FIG. 1 is a side elevation view of a preferred embodiment of the present invention in use in an underground utility system;

FIG. 2 is a side elevation view of the embodiment of FIG. 1 in a tamper state;

FIG. 3 is a side elevation view of an alternative embodiment of the present invention;

FIG. 4 is a side elevation view of the embodiment of FIG. 3 in a tamper state;

FIG. 5 is a side elevation view of the embodiment of FIG. 1 in use with a work of art;

FIG. 6 is a side elevation view of the embodiment of FIG. 5 in a tamper state;

FIG. 7 is a front view of the embodiment of FIG. 3 in use in a spark sensitive room;

FIG. 8 is a side elevation view of the embodiment of FIG. 7 also depicting a light source, a light receiver and a relay;

FIG. 9 shows a front side of a control unit which accommodates the preferred embodiments of the present invention;

FIG. 10 shows back side of the control unit of FIG. 9;

FIG. 11 shows a cross sectional view of another preferred embodiment of the present invention in a non-attenuated state; and

FIG. 12 shows a cross sectional view of the embodiment in FIG. 11 in an attenuated or alarmed state.

### DETAILED DESCRIPTION OF THE PRESENT INVENTION

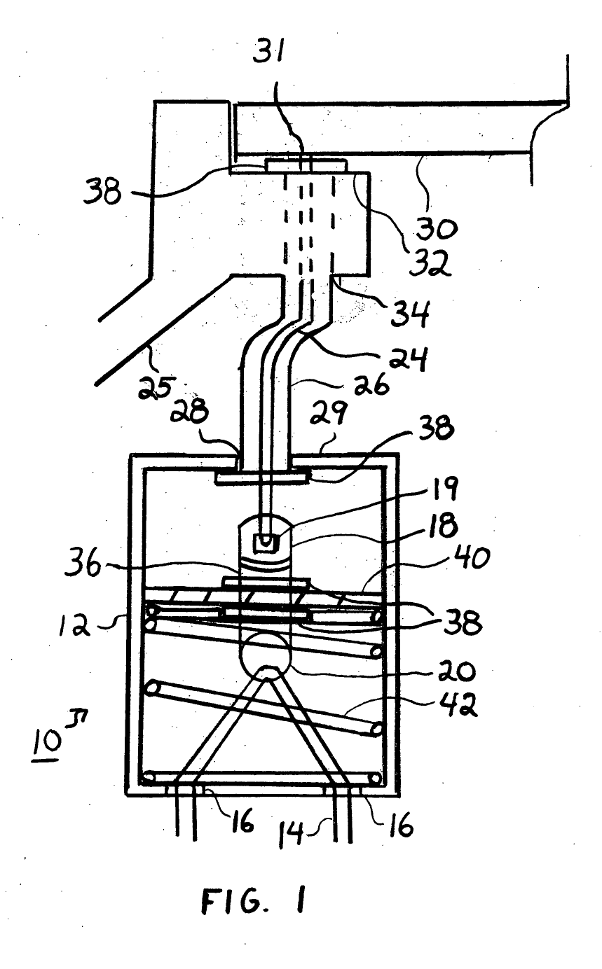

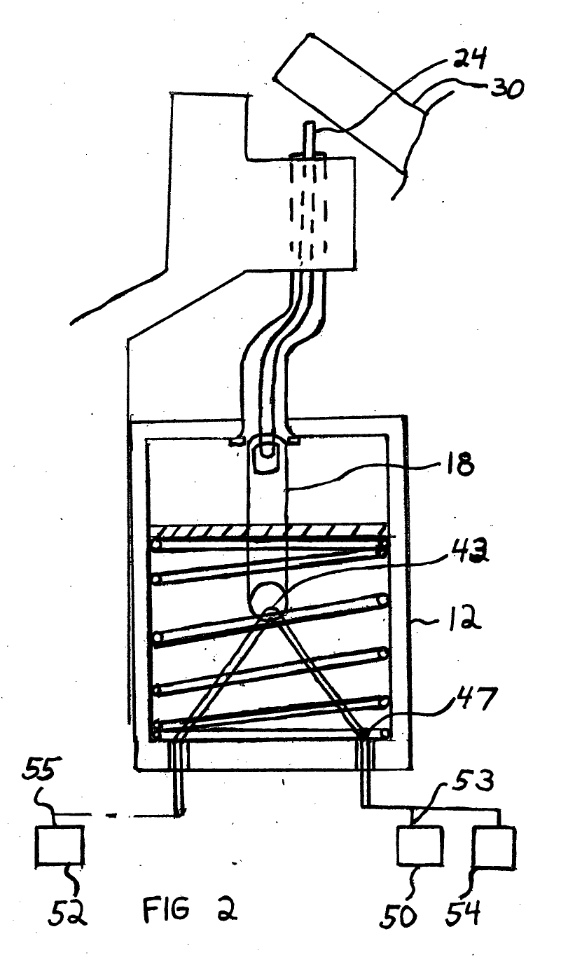

Referring now to FIGS. 1 and 2, a fiber optic cable sensor 10 in accordance with a preferred embodiment of the present invention includes a cable housing 12 mounted adjacent to an interior manhole wall 25. A fiber optic cable 14 runs through a pair of openings 16 disposed through the cable housing 12. For an entire manhole system it is desirable to install a cable housing 12 of the present invention adjacent to each individual manhole cover 30 and run a single fiber optic cable 14 through each individual cable housing 12. Thus, each manhole cover 30 of the system would be pre-assigned a specific location or length along the fiber optic cable 14, the reasons of which will become apparent with further reading.

A push/pull cable 24 extends through an opening 28 located at the top 29 of the cable housing 12 and contacts a bottom surface 31 of the manhole cover 30 which rests on an annular rim 32. In the embodiment shown in FIGS. 1 and 2, the push/pull cable 24 is routed within a conduit 26 which runs through an opening 34 in the annular rim 32. Alternatively, the conduit 26 may run to the inside of the annular rim 32 so that it is not necessary to install an opening 34 into an existing annular rim 32.

By routing the conduit 26 through the opening 34 in the annular rim 32, the conduit 26 becomes protected from unnecessary damage by those who seek access through the manhole, such as for maintenance.

Turning back to the cable housing 12, the fiber optic cable 14 is threaded through an opening 20 in a rigid linkage 18 disposed within the cable housing 12. At an opposite end of the rigid linkage 18, the push/pull cable 24 is attached through a second opening 19 within the rigid linkage. It should become readily apparent that other attaching methods may also be used to connect the push/pull cable 24 to the rigid linkage 18.

The rigid linkage 18 includes a threaded section 36 that allows fixed attachment to an elastic force compression cover 40 via a pair of locknuts 38. Thus the rigid linkage 18, the push/pull cable 24 and the elastic force compression cover 40 are stationary with respect to each other or, in other words, move together.

The weight of the manhole cover 30 forces the push/pull cable 24, the rigid linkage 18 and the elastic force compression cover 40 together downwardly, thus compressing a spring 42 as shown in FIG. 1.

Referring now to FIG. 2, the manhole cover 30 is removed to gain access to the manhole system. The force of the spring 42 now forces the compression cover 40, the push/pull cable 24 and the rigid linkage 18 together upwardly. When the rigid linkage 18 moves upwardly, the angle at which the fiber optic cable 14 threads through the opening 20 in the rigid linkage 18 becomes significantly decreased, which is called a microbend 43 in the fiber optic cable 14.

To keep sure that a microbend 43 is created, it is sometimes necessary to secure, by epoxy 47, portions of the fiber optic cable 14 to the housing 12.

Still referring to FIG. 2, a light source 50 transmits a light pulse through the fiber optic cable 14 from a first cable end 53 to a second cable end 55 wherein the light intensity is measured by a photodetector 52. It should be noted that a number of fiber optic cable sensors 10 can be installed between the light source 50 and the photodetector 52.

When the measured light intensity falls below a predetermined threshold level, such as is caused by the microbend 43 in the fiber optic cable 14, an optical time domain reflectometer (“OTDR”) 54 automatically triggers on.

Using known technology, the OTDR 54 locates the position of the microbend 43 along the fiber optic cable 14. OTDR technology determines an amount of backscattered light at each point along the fiber optic cable 14. A fiber optic cable 14 inherently contains an even distribution of impurities which forces a reflection of light back toward the light source. The OTDR 54 utilizes a second photodetector (not shown) that receives the backscattered light.

Since each fiber optic cable sensor 10 is assigned a predetermined distance, or length, along the fiber optic cable 14, it is now known which fiber optic cable sensor 10 contains the microbend 43. Thus it is known which manhole cover 30 has been removed.

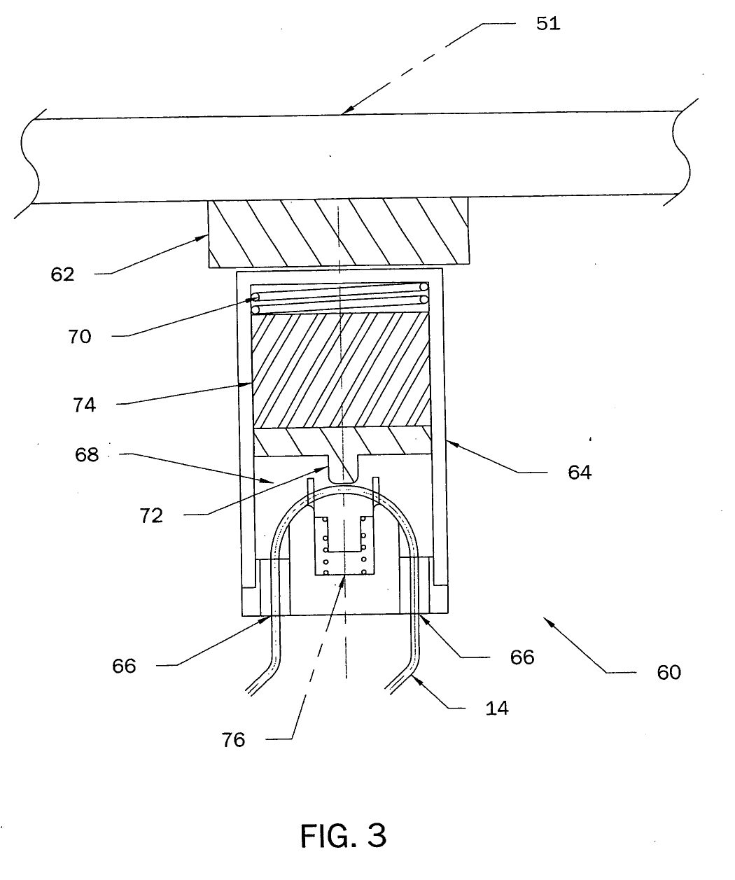

Turning now to FIG. 3, there is shown an alternative embodiment of a fiber optic cable sensor 60 the present invention. An access device 51, such as a door or a manhole cover, or even a work of art includes a magnetic portion 62. Alternatively, the access device 51 itself can be magnetically attractive.

A fiber optic cable housing 64 adjacently disposed to the magnetic portion 62 includes a fiber optic cable 14 running through a pair of housing openings 66. A spring loaded plunger 68 includes a spring 70, a plunger head 72 and a magnetic component 74.

Still referring to FIG. 3, magnetic component 74 and magnetic portion 62 are closely positioned to create a magnetic force which overcomes the elastic force provided by the spring 70, thus forcing the plunger 68 to an upward position.

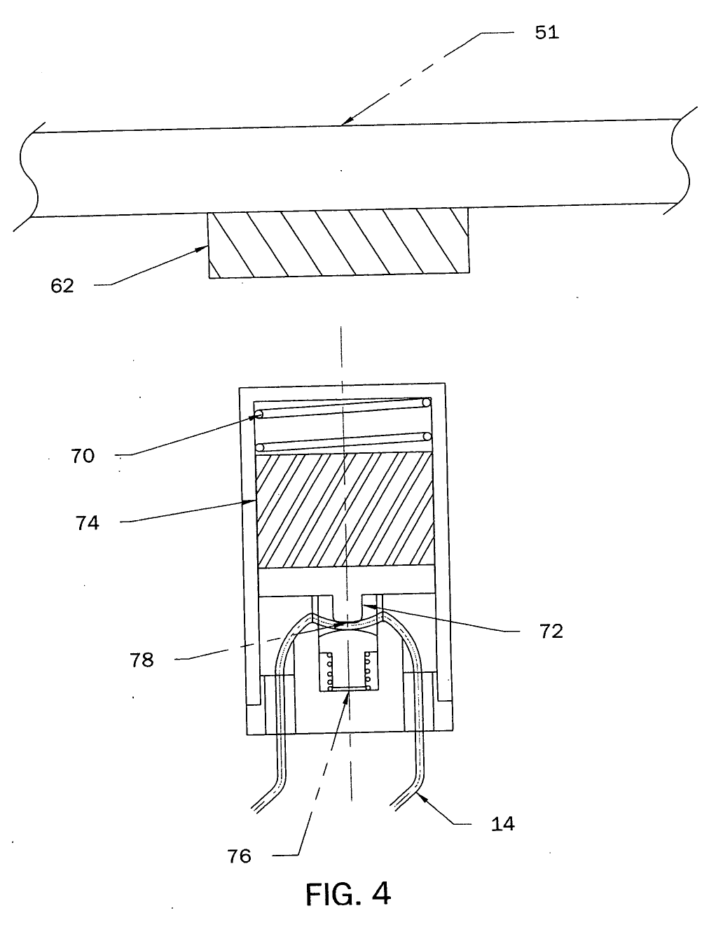

When the access device 51 is moved away from the housing, shown in FIG. 4, such as during a tamper or intrusion attempt, the magnetic force between the magnetic components dissipates. Thus, the elastic force of the spring 70 takes over, thereby forcing the plunger head 72 into an attenuation well 76, which causes a microbend 78 in the fiber optic cable, shown in FIG. 4. The location of the tamper of intrusion attempt is easily discerned using the method previously described herein.

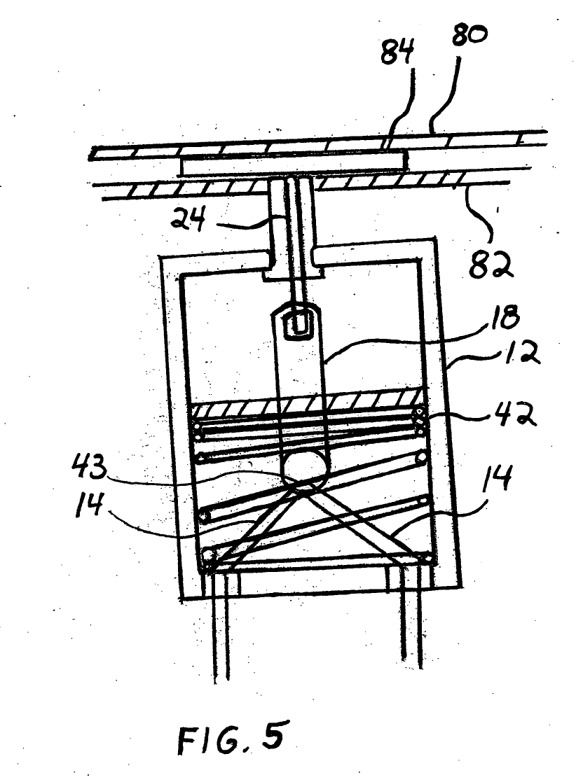

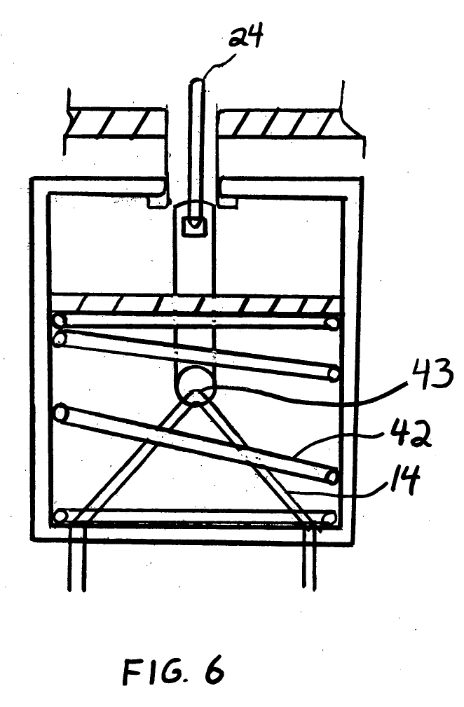

Referring now to FIGS. 5 and 6, there is shown how a work of art 80 or other valuable object is protected from theft in accordance with the present invention. The cable housing 12 having the push/pull cable 24 is disposed within or behind a wall 82 or other structure which supports the work of art 80. A protruding member 84 extends behind the work of art 80 and forces the push/pull cable 24 inward when the work of art 80 is displayed at its appropriate location. When the work of art 80 is removed or stolen the spring 42 pushes the protruding member 84 outward, thus forming the microbend 43 in the fiber optic cable in much the same fashion as described in the embodiment of FIGS. 1 and 2 herein.

As a result, an OTDR (not shown) functions as similarly described to indicate the location of the microbend 43 and, hence, also indicate which work of art 80 has been corrupted.

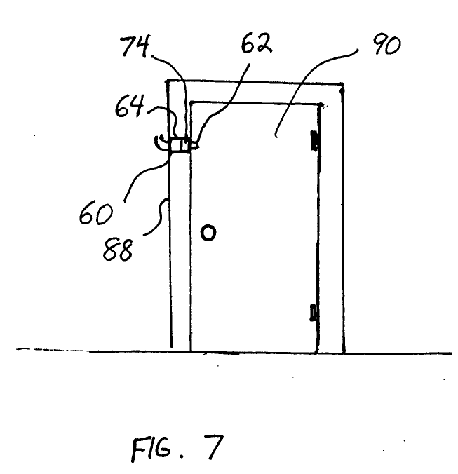

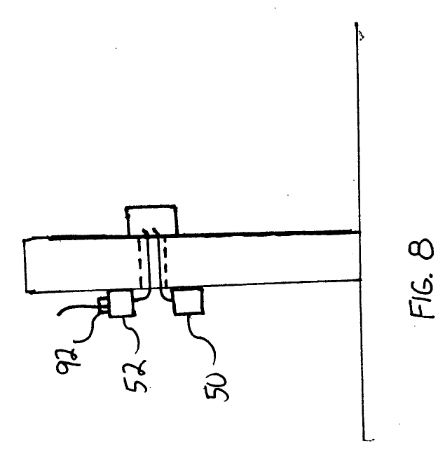

Referring now to FIGS. 7 and 8, there is shown how an intrusion attempt into a spark sensitive room is monitored in accordance with the present invention. The fiber optic cable sensor 60, also depicted in FIGS. 3 and 4, includes the cable housing 64 mounted to a door jamb 88 or molding. A magnetic component 62 mounted to the door 90 mutually attracts the magnetic component 62 of the cable housing 64. A light source 50 transmits a light signal having a predetermined receivable intensity to a light detector 52.

When the door becomes opened the magnetic attraction disappears and the spring 70 forces the plunger head 72 into the attenuation well 76, as depicted in FIG. 4. Thus, the microbend 78 is created in the fiber optic cable 14, thereby dropping the receivable light intensity below a predetermined level. A relay 92 responsive to the reduction in received light intensity sends a signal that the door 90 to the spark sensitive room has been impermissibly tampered.

The above described systems will also work with an OTDR as the sole light transmitting and receiving sources. One feature of the above described systems is that assets and manhole systems can be monitored on a continuous basis from a remote location. An added benefit with using the above described system in a manhole structure is that very limited cable installation is necessary because fiber optic cabling presently exists in many manhole systems.

Each of the above described systems are tamper proof because it is impossible to cut a fiber optic cable without a detection of loss of light intensity at the receiving end. Thus, attempts to short wire the system automatically fail.

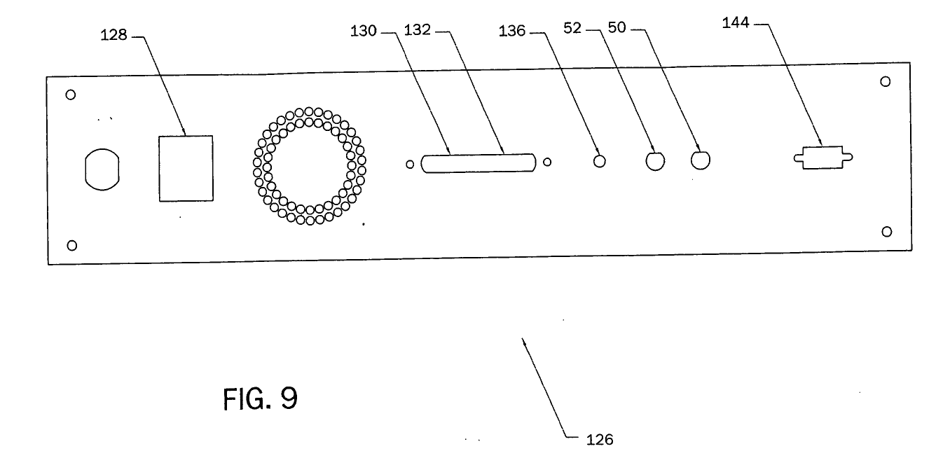

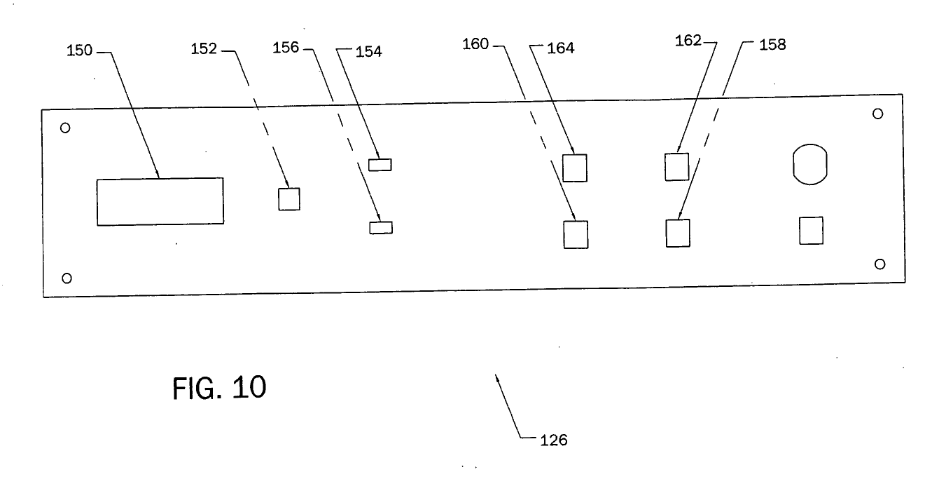

Referring now to FIGS. 9 and 10, the intrusion detection sensitivity is adjusted by turning a sensitivity screw 136. In the embodiment depicted in FIG. 2, only the first end 53 of the fiber optic cable 14 is coupled to a light source port 140. The light source 50 emits a known quantity of light through the first end 53 of the fiber optic cable 14 and transmitted light is returned to the light detector 52. The sensitivity is adjusted by altering the required intensity of transmitted light detected at the second end 55 of the fiber optic cable 14 to produce a positive intrusion detection.

For the embodiment depicted in FIGS. 1-6, the cable is looped back to the control panel 126 so that light can be detected at the second end 55 as well as through backscattering means at the first end 53 of the fiber optic cable 14. The sensitivity is adjusted by altering the level of received light that is required to produce a positive intrusion detection.

Cable data is continuously transmitted to a computer through a RS-232 serial port and interface 144. Computer software programs receive and manipulate this cable data. The computer allows a system operator to monitor the fiber optic cable 14 from a remote location.

A front panel 148 of the control panel 126 includes an LCD display 150, which displays the length of fiber optic cable 14 through which the emitted light has passed. In a typical example, the light source 50 emits a light pulse and then the detector 52 or OTDR 54 receives backscattered light at varying increments in time. The LCD display 150 shows the cable lengths at these small increments in time. Alternatively, the detector 52 receives the transmitted light at the second end 55 of the fiber optic cable 14.

When an attenuation of the light signal is detected, the OTDR 54 searches for the location of the microbend 43 and the display locks onto the length at the intrusion or microbend location.

Looking at FIG. 9, a back side 124 of the control panel 126 includes a standard 110 volt single phase power receptacle 128. One relay pair 130 controls three pairs of contacts 132 to control external system devices, such as, perimeter lights and phone alarms (not shown). For example, the first two contact pairs are open, thereby having the perimeter lights in an OFF state. When an intrusion is detected the relay pair 130 causes the contacts to close, thereby putting the perimeter lights or other alarm to an ON state.

Where no intrusion is detected, the control panel 126 continues such incremental testing until the length of the perimeter is reached. It should be noted that the units can be cascaded to provide an indefinite cable length. Further, a multiplicity of cables can be installed to one control panel 126 wherein an optical switcher (Not shown) disposed in the control panel 126 allows for the monitoring of the light signal through the multiple cables.

An alarm LED 152 becomes illuminated when an intrusion is detected. A system ready LED 154 lets the user know that the control panel 126 has begun operation. A power display 156 illuminates when electric power is provided to the unit.

A mute switch 158 provides the ability to mute an alarm. A system test switch 160 provides the ability to simulate a break for purposes of testing how the control panel 126 responds to an intrusion.

A reset 162 functions in either the ENABLED state or DISABLED state. When the reset 162 is ENABLED, an alarm will cease when the intrusion detection condition is no longer detectable. In DISABLED state, the alarm continues upon an intrusion detection condition until the alarm is keyed to stop. Finally, a power switch 164 turns the unit on and off.

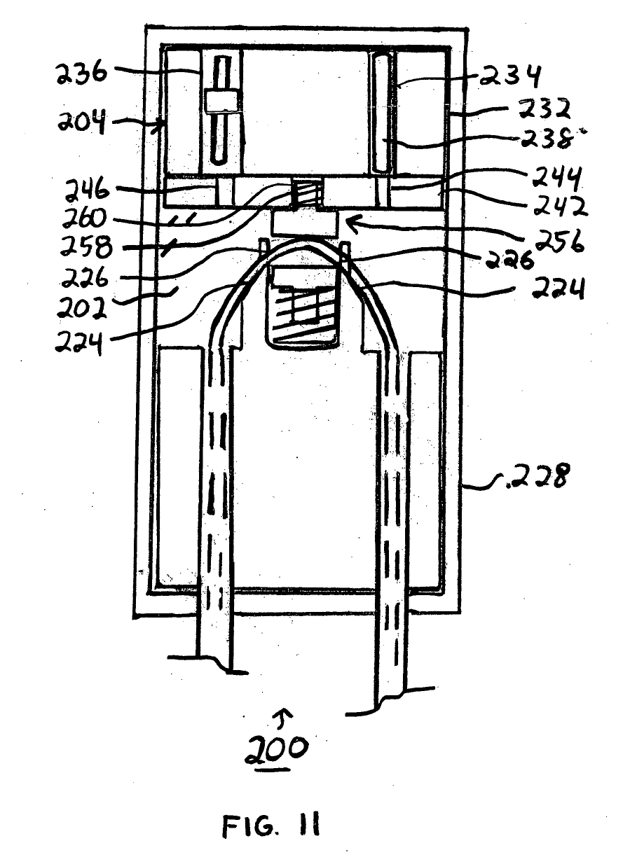

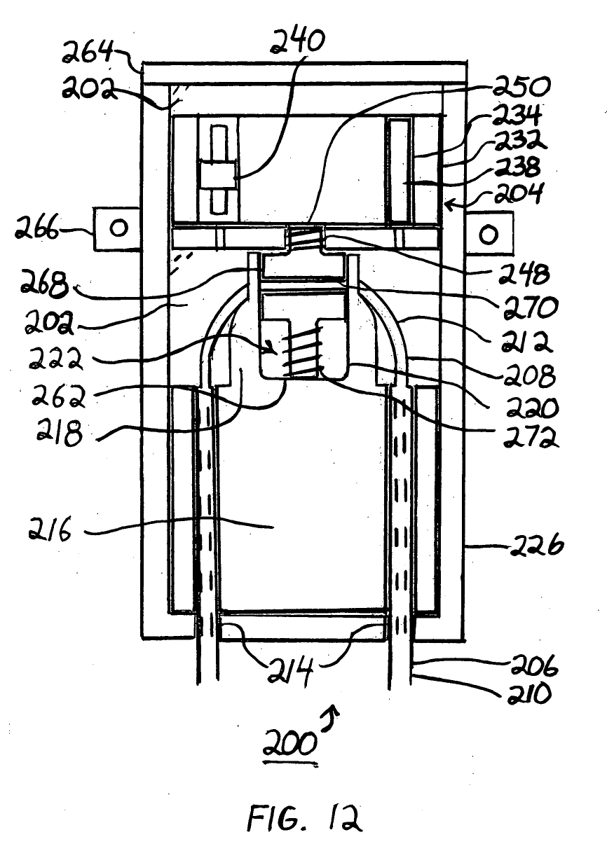

Turning now to FIGS. 11 and 12, yet another preferred embodiment of a fiberoptic cable sensor 200 in accordance with yet another embodiment of the present invention utilizes a hydraulic fluid 202 in conjunction with a magnetic actuator 204 to produce a measurable attenuation to a light signal through a fiberoptic cable 206.

An intermediate portion 208 of the fiber optic cable 206 is stripped of its outer jacket 210 to expose a bare fiber portion 212, the length of which shall become apparent. The fiberoptic cable 206 is threaded through a pair of openings 214 in a base member 216 so that the outer jacket 210 snugly fits within the openings 214 and the bare fiber portion 212 is upwardly exposed.

The base member 216 includes an annular upright member 218 which forms a cylindrical cavity 220. Prior to threading the fiberoptic cable 206 through the base member 216, a first spring loaded cap 222 is fitted within the cylindrical cavity 220.

Beveled shoulders 224 in the upright member 218 helps define a bend radius of the fiberoptic cable 206, depicted in FIG. 11. A pair of opposing slots 226 in the upright member 218 ensures that the fiberoptic cable 206 does not roll away from the upright member 218.

The base member 216 is now fitted to a cylindrical housing ring 226 such as by threading or friction fitting, depicted in FIG. 11. Alternatively, the base member 216 slides into a drum shaped housing member 228 such that the openings 214 in the base member 216 align with a pair of openings 230 in the drum shaped housing member 228, depicted in FIG. 12. It should be noted that the outer jackets 210 of the fiber optic cable 206 must snugly fit in the openings 214 so that hydraulic fluid 202 does not leak from the sensor 200.

The fiber optic cable 206 is now in place having been threaded through the base member 216, over the beveled shoulders 224 and through the slots 226 in the upright member 218 to form the predetermined bend radius.

A solid cylindrical shaped magnet 232 includes a first opening 234 and second opening 236 extending therethrough. A two-way valve 238 snugly fits within the first opening 234 and allows the hydraulic fluid 202 to pass therethrough in both directions. The second opening 236 in the magnet 232 contains a one-way valve 240 snugly fitted therein. The one-way valve 240 has a larger opening than the two-way valve 238 and allows the hydraulic fluid 202 to pass only in the upward direction.

A stainless steel ring member 242 includes a first opening 244 and a second opening 246 which are axially aligned to allow passage of the hydraulic fluid 202 to and from the first and second openings 234, 236 of the magnet 232, respectfully. A central opening 248 in the stainless steel ring 242 forms a cavity 250 when the ring 242 is fixed to the magnet 232 through the magnetic attraction. It should be noted that the cavity 250 could also be bored directly into a central portion of the magnet 232 to produce the same effect. However, machining magnets is laborious and costly.

A second spring cap 256 contains a stem portion 258 outwardly bounded by a spring member 260. Both the stem portion 258 and the spring member 260 fit within the cavity 250 and extend slightly downwardly therefrom. When the magnet 232 moves downward, the second spring cap 256 forces the first spring cap 222 downward until the first spring cap 222 contacts a bottom portion 262 of the cylindrical cavity 220.

After the magnet 232, stainless steel ring 242 and second spring cap 256 are inserted into the drum shaped housing 228, the remaining space is filled with the hydraulic fluid 202. A top member 264 is then fitted to the drum shaped housing 228, either by threading or friction fitting, to form a leak proof structure.

In use, the housing 228 further contains a flange 266 extending therefrom which allows the sensor 200 to be installed adjacent to a metallic object, such as a manhole cover (not shown). When the sensor 200 is finally installed adjacent to the manhole cover, the attractive force between the magnet 232 and the manhole cover draws the magnet 232 upward thus displacing the hydraulic fluid 202 through the two way valve 238.

When the manhole cover or other magnetically attractive object is removed, the magnet 232 moves downward and displaces the hydraulic fluid 202 through both the one way valve 240 and the two way valve 238. A head portion 268 of the second spring cap 256 is driven into the cylindrical cavity 220 between the upright member 218, which causes the fiberoptic cable 206 to form a microbend 270.

As the second spring cap 256 presses down on the fiber optic cable 206, it also pushes down on the first spring cap 222. The first spring cap 222 finally engages the bottom 262 of the cylindrical cavity 220. Hence, the magnet 232, the second spring cap 256 and the first spring cap 222 come to rest, shown in FIG. 12.

The attenuation to the light signal passing through the fiberoptic cable 206 is readily discerned using known optical time domain reflectometer technology. Thus, the location of the microbend 270 is determined. The spring 260 temporarily maintains the downward pressure on the second spring cap 256 as the magnet 232 begins to rise, thus maintaining the attenuation over a measurable duration of time.

The attenuation magnitude depends on the length of the first spring cap 222. A shorter cap 222 creates a greater microbend and thus a greater attenuation.

Once the manhole cover is placed back into position, the magnet 232 moves upward once again. The hydraulic fluid 202 passes downwardly through the two-way valve 238 only, thus slowing the upward movement of the magnet 232 which acts in conjunction with the spring 260 to hold the attenuation long enough to accurately locate the position of the microbend 270 along the fiberoptic cable 206 length.

A spring member 272 in the first spring cap 222 forces the first spring cap 222 upward thus boosting the fiber optic cable 206 towards its original bend radius. The resiliency of the fiber optic cable 208 allows it to assume its original bend radius.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. An apparatus that determines the location of an impermissible movement of a predetermined magnetically attractive object, said apparatus comprising:
a housing having a top portion and a bottom portion said top portion being adjacently disposed to said predetermined magnetically attractive object, said bottom portion further including a pair of cable openings disposed there through;
a support member disposed in the bottom portion of said housing, said support member having a pair of openings disposed therethrough, said openings axially aligned with said openings in the bottom portion of said housing, said support member further having an exterior surface of such size and shape to snugly fit in said bottom portion;
a fiber optic cable disposed through said opening and over a top portion of said support member, said fiber optic cable forming a first bend radius;
a hydraulic fluid disposed within said housing;
a magnetic member disposed within said housing, said magnetic member having an exterior size and shape substantially equivalent to an interior size and shape of said housing, said magnetic member further including a first opening and a second opening disposed therethrough, wherein said magnetic member is disposed at the top most portion of said housing when said predetermined magnetically attractive object is adjacent thereto, and wherein said magnetic moves towards the bottom portion when said predetermined magnetically attractive object is moved away from said top portion, whereby said magnetic member forces a microbend to said fiber optic cable, said microbend resulting in a measurable level of backscattering of a light signal passing through said fiber optic cable;
a one-way valve disposed within said first opening which allows said hydraulic fluid to flow in a single direction towards the top portion;
a two-way valve disposed within said second opening which allows said hydraulic fluid to flow in either direction;
an optical time domain reflectometer optically connected to said fiber optic cable for determining the length along the cable of said predetermined magnetically attractive object.

2. The apparatus of claim 1, wherein said magnetic member further includes a downwardly disposed cavity having a spring cap disposed therein, and wherein said spring cap contacts and forces said microbend when said magnetic member moves downward.

3. The apparatus of claim 2, further including a magnetically attractive ring member having a first and second opening disposed therethough, wherein said first and second openings axially align with the bottom of said first and second openings of said magnetic member, and said magnetically attractive ring member further includes a central opening such that said cavity is formed when said ring member is magnetically connected to said magnetic member.

4. The apparatus of claim 1, wherein said bottom portion further includes an upright member, wherein said upright member forms a central cavity therein.

5. The apparatus of claim 4, further including a spring cap disposed in said central cavity.

6. The apparatus of claim 4, wherein said upright member further includes a pair of slots, wherein said fiberoptic cable is fitted within said slots.

7. The apparatus of claim 1, wherein said housing and support member are one piece die casted.

8. The apparatus of claim 2, wherein said bottom portion further includes an upright member, wherein said upright member forms a central cavity therein.

9. The apparatus of claim 8, further including a spring cap disposed in said central cavity.

10. The apparatus of claim 8, wherein said upright member further includes a pair of slots, wherein said fiberoptic cable is fitted within said slots.

11. The apparatus of claim 8, further including a spring cap disposed in said central cavity, and wherein said upright member further includes a pair of slots, wherein said fiberoptic cable is fitted within said slots over said spring cap.
